(19) United States
(12) Patent Application Publication
(10) Pub. No.: US 2003/0053130 A1
(43) Pub. Date: Mar. 20, 2003

(54) Recording apparatus, interface control apparatus, and interface control method

(76) Inventor: Shinichi Omo, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/227,345

(22) Filed: Aug. 26, 2002

(30) Foreign Application Priority Data
Aug. 29, 2001 (JP) 2001-259404

(51) Int. Cl. B41B 1/00; G06F 15/00

(52) U.S. Cl. 358/1.16

(57) ABSTRACT

To provide a recording apparatus which can avoid a retry of recording from the beginning due to interruption of a data transfer, when the transfer of print data is interrupted and retransfer of the print data is started, a count value RD_CNT of a first counter is initialized, a count value WD_CNT of a second counter is held, the data read out from an FIFO is abandoned for a period of time from the start of the retransfer of the print data until the count value RD_CNT of the first counter exceeds the count value WD_CNT of the second counter, and when the count value RD_CNT of the first counter exceeds the count value WD_CNT of the second counter, the data read out from the FIFO is written into an input buffer.

### BACKGROUND OF THE INVENTION

1. Field of the Invention

The invention relates to a recording apparatus which is connected to an external apparatus via an interface that can divide print data from the external apparatus on a block unit basis and transfer it and, in the case where the transfer of the print data is interrupted, can retransfer the print data and which executes a print output on the basis of the print data transferred via the interface. The invention also relates to an interface control apparatus and an interface control method.

2. Related Background Art

In a recording apparatus having an interface according to IEEE1284, print data transferred from a host computer is once stored into an input buffer (buffer which operates as an FIFO) and while the data in the input buffer is sequentially read out, a process such as “print command analysis”, “transfer to image buffer”, or the like is executed. This is because since the interface according to IEEE1284 executes the data transfer on a byte unit basis and its transfer speed is relatively low, it is necessary to perform the data transfer as efficiently as possible. The above construction is effective to substantially eliminate “transfer inhibition time which occurs temporarily” in accordance with a processing situation in the recording apparatus.

In a USB (Universal Serial Bus) interface, a system for performing the data transfer on a block unit basis in which one block is constructed by several bytes (for example, 64 bytes) is used. Buffering of the bytes (for example, 64 bytes) is once executed in an FIFO provided in a USB interface circuit and data read out from the FIFO is transferred into the input buffer and processed in a manner similar to that in the interface according to IEEE1284.

As another interface system, there is an interface according to IEEE1394. Also in such an interface, since a system of performing the data transfer on a block unit basis of several bytes (for example, 512 bytes) in a manner similar to the USB is used, it can be applied to the recording apparatus by processes similar to those of the USB.

In case of the USB, a reset signal of a bus is not generated in cases except for a case where connection of a cable to which the recording apparatus is connected is disconnected or printing is stopped from the host computer.

However, unlike the USB system, in the interface according to IEEE1394, if a situation of the bus change such as “another apparatus is connected to the bus or a power source of the connected apparatus is turned on/off” or the like occurs, the bus reset occurs, so that the data transfer is interrupted and the data transfer from the beginning is executed again.

For example, although a similar phenomenon also occurs similarly even in an apparatus such as a hard disk, in case of the hard disk, since data is “overwritten” again onto the same data, no problem occurs actually. In case of the recording apparatus, however, data cannot be “overwritten” again with respect to the portion which has already been recorded.

In the recording apparatus, therefore, it is necessary to deliver paper at a point when the data transfer is interrupted and newly start the recording.

### SUMMARY OF THE INVENTION

It is an object of the invention to provide a recording apparatus, an interface control apparatus, and an interface control method, in which a retry of the recording from the beginning due to interruption of a data transfer can be prevented.

To accomplish the above object, according to the invention, there is provided a recording apparatus which is connected to an external apparatus via an interface that can divide print data from the external apparatus on a block unit basis and transfer it and, in the case where the transfer of the print data is interrupted, can retransfer the print data and which executes a print output on the basis of the print data transferred via the interface, comprising: a first buffer for holding and managing the print data transferred via the interface on a block unit basis; a second buffer for storing the print data read out from the first buffer; a first counter for counting the number of data read out from the first buffer; a second counter for counting the number of data written in the second buffer; and a comparing unit of the first and second counters, wherein when the transfer of the print data is interrupted and the retransfer of the print data is started, the first and second counters are controlled so as to initialize a count value of the first counter and hold a count value of the second counter, and a control is made in a manner such that the data read out from the first buffer is abandoned for a period of time from the start of the retransfer of the print data until it is determined by an output of the comparing unit that the data is the data which has already been written into the second buffer, and if it is decided by the output of the comparing unit that the writing into the second buffer is not executed yet, the data read out from the first buffer is written into the second buffer.

According to the invention, there is also provided a recording apparatus which is connected to an external apparatus via an interface that can divide print data from the external apparatus on a block unit basis and transfer it and, in the case where the transfer of the print data is interrupted, can retransfer the print data and which executes a print output on the basis of the print data transferred via the interface, comprising: a first buffer for holding and managing the print data transferred via the interface on a block unit basis; a second buffer for storing the print data read out from the first buffer; a first counter for counting the number of data read out from the first buffer; a second counter for counting the number of data written in the second buffer; a register for holding a count value of the second counter; and a comparing unit of the first counter and the register, wherein when the transfer of the print data is interrupted and the retransfer of the print data is started, the first counter is controlled so as to initialize a count value of the first counter, and a control is made in a manner such that the data read out from the first buffer is abandoned for a period of time from the start of the retransfer of the print data until it is determined by an output of the comparing unit that the data is the data which has already been written into the second buffer, and if it is decided by the output of the comparing unit that the writing into the second buffer is not executed yet, the data read out from the first buffer is written into the second buffer.

According to the invention, there is also provided a recording apparatus which is connected to an external apparatus via an interface that can divide print data from the external apparatus on a block unit basis and transfer it and, in the case where the transfer of the print data is interrupted, can retransfer the print data and which executes a print output on the basis of the print data transferred via the interface, comprising: a first buffer for holding and managing the print data transferred via the interface on a block unit basis; a second buffer for storing the print data read out from the first buffer; a counter for counting the number of data read out from the first buffer; and a register for holding a count value of the counter which is obtained when it changes most, wherein when the transfer of the print data is interrupted and the retransfer of the print data is started, the counter is controlled so as to initialize the count value of the counter, and a control is made in a manner such that the data read out from the first buffer is abandoned for a period of time from the start of the retransfer of the print data until the count value of the counter exceeds the count value in the register, and when the count value of the counter exceeds the count value held in the register, the data read out from the first buffer is written into the second buffer.

According to the invention, there is also provided an interface control apparatus comprising: a management unit for managing an amount of data received from an external apparatus and stored in a memory; and writing means which operates in a manner such that when data is again received from the external apparatus, on the basis of the management by the management unit, the data up to the previously stored data in the data received again from the external apparatus is not stored into the memory, and the data after the previously stored data in the data received again from the external apparatus is written into the memory.

### BRIEF DESCRIPTION OF THE DRAWINGS

FIG. 1 is a block diagram showing a principal construction of an interface of a recording apparatus according to the first embodiment of the invention;

FIG. 2 is a timing chart showing a data transfer during a period of time from the start of data transfer to the recording apparatus of FIG. 1 until the occurrence of a bus reset;

FIG. 3 is a timing chart showing retransfer of data after the occurrence of the bus reset; and

FIG. 4 is a block diagram showing a construction of a principal section of a recording apparatus according to the second embodiment of the invention.

### DETAILED DESCRIPTION OF THE PREFERRED EMBODIMENTS

Embodiments of the invention will be described hereinbelow with reference to the drawings.

(First Embodiment)

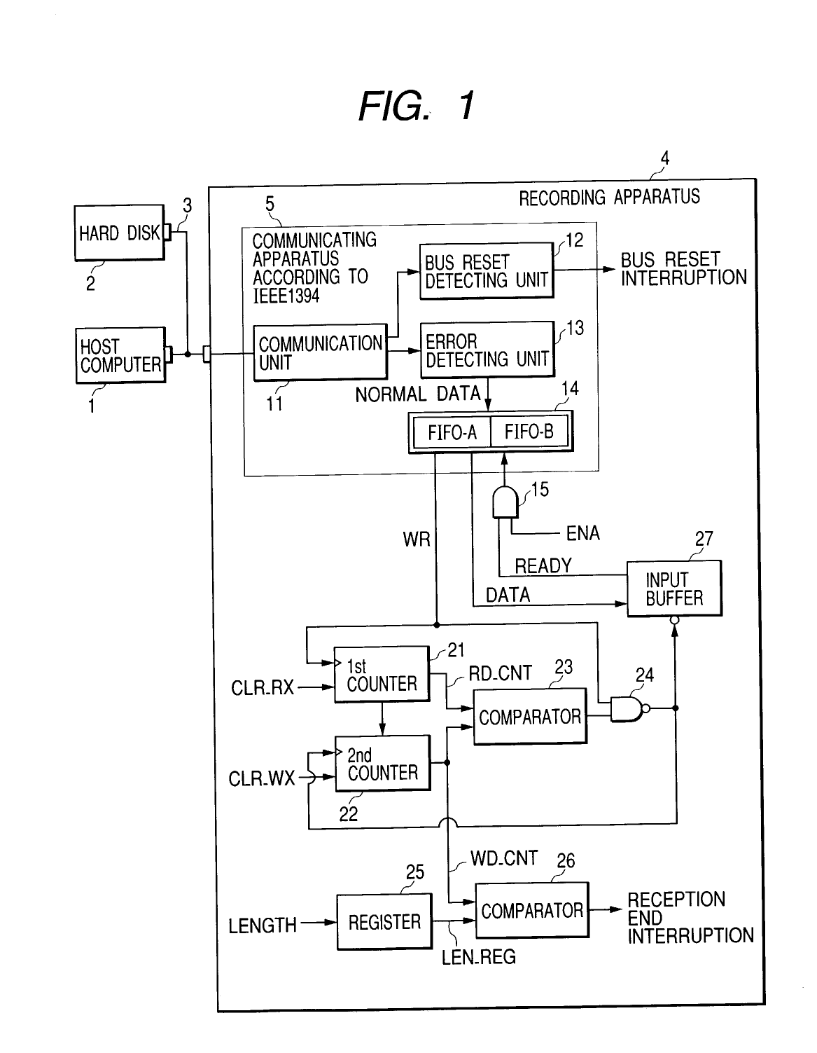

FIG. 1 is a block diagram showing a principal construction of an interface of a recording apparatus according to the first embodiment of the invention.

As shown in FIG. 1, a recording apparatus 4 is connected to a host computer 1 as an external apparatus via an external bus 3 according to IEEE1394. Together with the host computer 1 and recording apparatus 4, a hard disk drive 2 is connected to the external bus 3. Print data (data length L) is divided on a preset block unit basis (one-block length P, remainder length M) and transferred from the host computer 1 to the recording apparatus 4 via the external bus 3. If the transfer of the print data is interrupted due to the occurrence of a bus reset, occurrence of abnormality of the transfer data, or the like, the print data (data length L) is retransferred from the beginning.

The recording apparatus 4 has a printer engine (not shown) of an ink-jet type, electrophotographic type, or the like for printing the print data received from the host computer 1 via the external bus 3.

The recording apparatus 4 has a communicating apparatus 5 according to IEEE1394 which is connected to the external bus 3 and performs a communication control. The communicating apparatus 5 has a communicating unit 11, a bus reset detecting unit 12, an error detecting unit 13, and an FIFO 14. The communicating unit 11 constructs a physical processing unit which is connected to the external bus 3 and performs a communication control. When it is detected that a bus reset occurred on the external bus 3, the bus reset detecting unit 12 notifies a CPU (not shown) of the occurrence of bus reset interruption. The error detecting unit 13 detects errors of the data which was divided on a block unit basis and transferred from the host computer 1. The data which was determined to have normally been transferred from a result of this detection is stored into the FIFO 14. If the errors occur, the erroneous data is abandoned and the host computer 1 is requested to retransfer the data of the same block.

Only the data which was determined to be the correct data by the error detecting unit 13 is inputted into the FIFO 14. The FIFO 14 comprises a pair of FIFO-A and FIFO-B and is constructed in a manner such that even while one of them (for example, FIFO-A) is inputting the data from the error detecting unit 13, the data can be read out from the other (for example, FIFO-B).

The data read out from the FIFO 14 is sent to an input buffer 27. In this instance, information showing whether the input buffer 27 can receive the data or not is transmitted via a gate 15. When an READY signal showing that the data from the input buffer 27 can be received is at the “H” level and a write permission signal ENA from the CPU (not shown) is at the “H” level, the gate 15 notifies the FIFO 14 of the fact that the data can be written into the input buffer 27. Thus, the data read out from the FIFO 14 can be written into the input buffer 27.

Each time the data (DATA) of the block unit is subsequently read out, the FIFO 14 generates a WR signal for instructing the writing of the data.

When a WRX signal as an inversion output from a gate 24, which will be explained hereinlater, is inputted to the input buffer 27, the transferred data is once written into the input buffer 27. The written data is sequentially read out therefrom by the CPU. The input buffer 27 is called a ring buffer and constructed in a manner such that if an empty area is obtained by reading out the data, the next data can be sequentially inputted. The data read out from the input buffer 27 is developed and printed by a control system.

The WR signal from the FIFO 14 is inputted to a first counter 21 and the gate 24. The first counter 21 counts the number of WR signals from the FIFO 14 and supplies a count value RD_CNT to a comparator 23. The count value RD_CNT of the first counter 21 is cleared by a CLR_RX signal from the CPU (not shown).

The comparator 23 compares the count value RD_CNT of the first counter 21 and a count value WD_CNT of a second counter 22. When a relation of RD_CNT>WD_CNT is satisfied, the comparator 23 generates an output signal at the “H” level to the gate 24. When the output signal from the comparator 23 is at the “H” level, the gate 24 inverts the WR signal and outputs the WRX signal to the input buffer 27 and second counter 22. By the WRX signal, the data transferred from the FIFO 14 is written into the input buffer 27.

The second counter 22 counts the number of WRX signals from the gate 24 and supplies the count value WD_CNT to the comparator 23. The count value WD_CNT of the second counter 22 is cleared by a CLR_WR signal from the CPU (not shown). The count value WD_CNT of the second counter 22 is inputted to a comparator 26.

The comparator 26 compares the whole number LEN_REG of data which is transferred from the host computer 1 and held in a register 25 with the count value WD_CNT of the second counter 22. When a relation of LEN_REG=WD_CNT is satisfied, the comparator 26 generates a reception end interruption signal for notifying the CPU of the end of the data transfer.

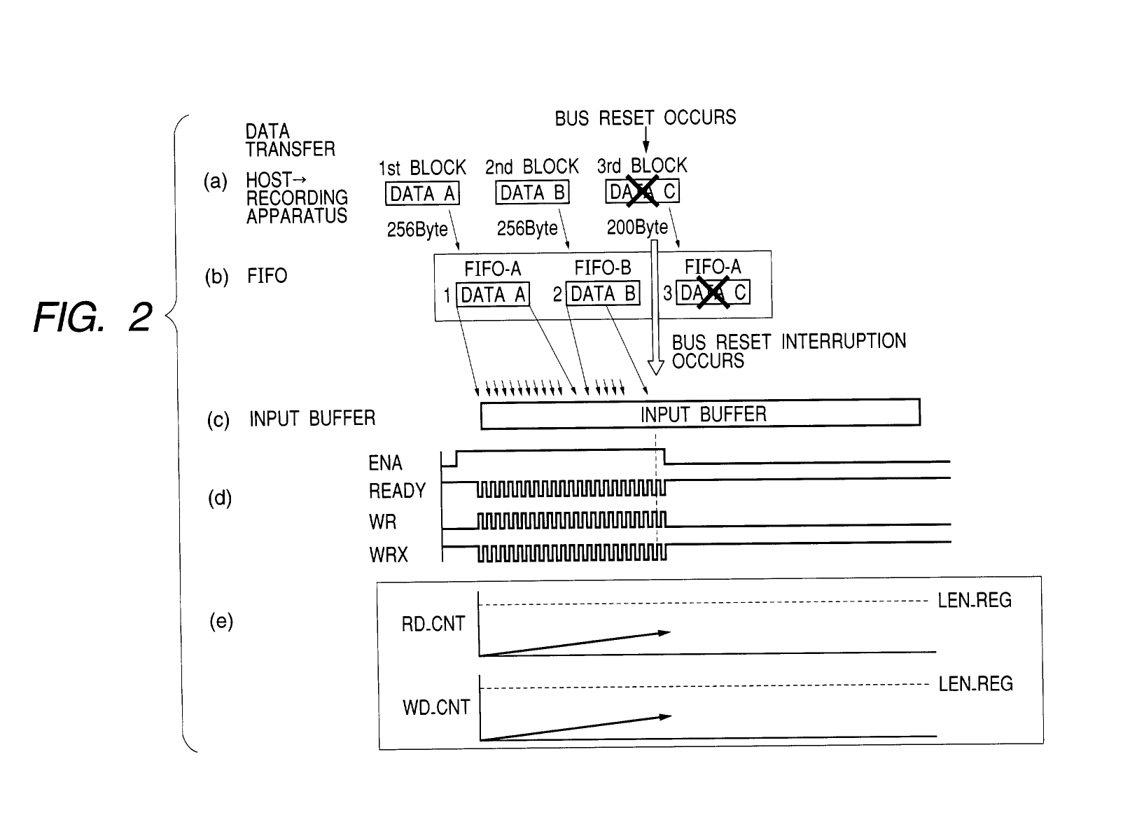

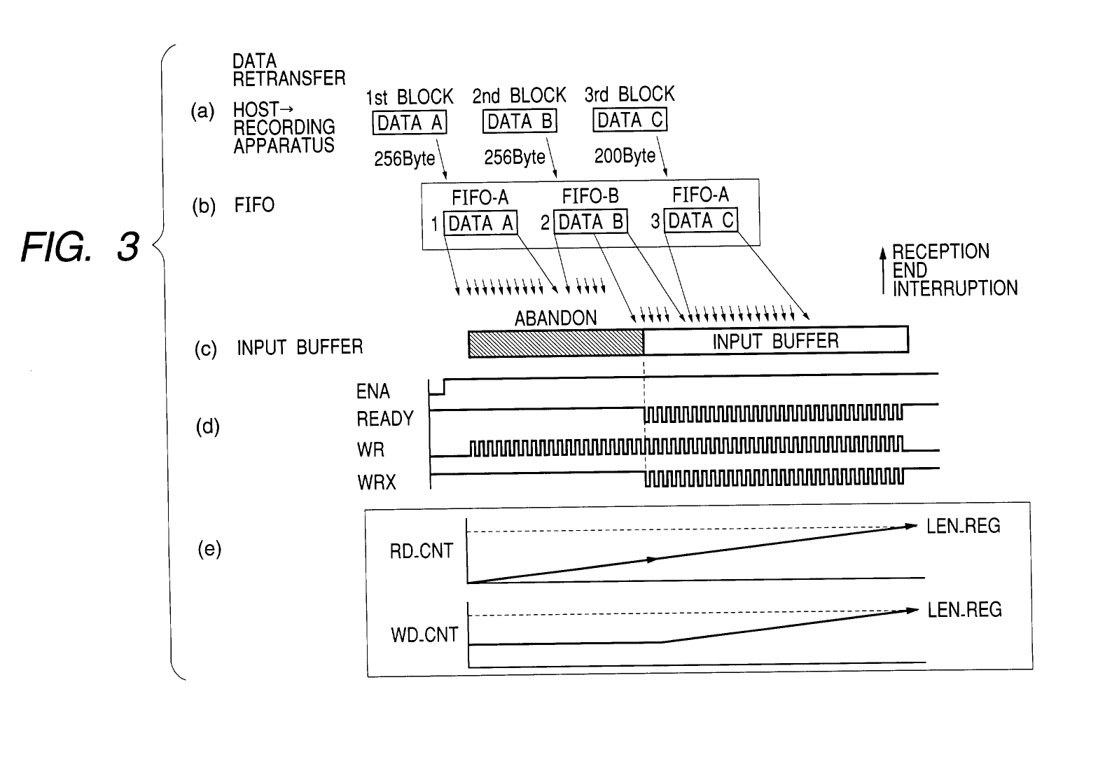

The operation of the recording apparatus 4 will now be described in detail hereinbelow with reference to FIGS. 2 and 3. FIG. 2 is a timing chart showing the data transfer during a period of time from the start of the data transfer to the recording apparatus of FIG. 1 until the occurrence of the bus reset. FIG. 3 is a timing chart showing the retransfer of the data after the occurrence of the bus reset.

Explanation will now be made with respect to a case where data of 712 bytes as a whole is divisionally transferred three times from the host computer 1 to the recording apparatus 4 in order of the first block P=256 bytes, the second block P=256 bytes, and the third block M=200 bytes (refer to (a) of FIG. 2). P denotes the length of one block and M indicates the remainder length.

At the start of the data transfer, the recording apparatus 4 communicates with the host computer 1 and confirms whether the data transfer is the normal data transfer or the data transfer which is executed after the bus reset by software. If it is confirmed that the data transfer is the normal data transfer, first, the count value RD_CNT of the first counter 21 and the count value WD_CNT of the second counter 22 are cleared and the whole number LEN_REG of data (712 in the embodiment) which is transferred from the host computer 1 is set into the register 25 (refer to (e) of FIG. 2). The ENA signal to the gate 15 is set to the “H” level (refer to (d) of FIG. 2).

When the data transfer from the host computer 1 is started and “data A” of the first block is normally transferred, it is held into FIFO-A in the FIFO 14 (refer to (b) of FIG. 2). Since both of the READY signal and the ENA signal are at the “H” level for “data A” in the FIFO 14, the writing operation of “data A” into the input buffer 27 is started (refer to (c) of FIG. 2).

Since the count value RD_CNT of the first counter 21 is updated to “+1” in response to a leading edge of the WR signal from the FIFO 14 and an output of the comparator 23 is set to the “H” level, the WRX signal as an inversion output of the WR signal is inputted to the input buffer 27 via the gate 24 and the writing operation is executed. The count value WD_CNT of the second counter 22 is updated to “+1” in response to a leading edge of the WRX signal as an inversion output (refer to (d) and (e) of FIG. 2).

The data of the second block is transferred to FIFO-B in the FIFO 14. The writing operation into the input buffer 27 is similarly executed. The count value RD_CNT of the first counter 21 and the count value WD_CNT of the second counter 22 are updated (refer to (d) and (e) of FIG. 2).

When the data of the third block is normally transferred, if FIFO-A in the FIFO 14 is empty, the data of the third block can be written into FIFO-A. In the embodiment, however, it is assumed that the bus reset occurred during the transfer of the data of the third block and the data transfer of the third block was interrupted (refer to (a) and (b) of FIG. 2). In this case, the error detecting unit 13 detects abnormality of the transfer data by a CRC check or the like and abandons the data without transferring it to the FIFO 14. In order to stop the operation for writing the data from the FIFO 14 into the input buffer 27 due to the bus reset interruption, the CPU sets the ENA signal to the “L” level (refer to (d) of FIG. 2). In the embodiment, the writing of the data of the second block into the input buffer 27 is interrupted on the halfway.

The interrupting process can be executed during the writing operation of the data of the second block as mentioned above or after completion of the writing operation of the data of the second block.

As mentioned above, the data transfer is executed until the bus reset occurs.

It is assumed that the bus reset occurs and the data is received again from the host computer 1. The recording apparatus 4 communicates with the host computer 1 and confirms whether the data transfer is the normal data transfer or the data transfer which is executed after the bus reset by software. If it is confirmed that the data transfer is the data transfer which is executed after the bus reset, as preparation for starting the retransfer of the data after the cancellation of the bus reset, first, the count value RD_CNT of the first counter 21 is cleared and the ENA signal is set to the “H” level (refer to (d) of FIG. 3). The second counter 22 holds the previous count value WD_CNT and the register 25 holds the previous value LEN_REG, respectively (refer to (e) of FIG. 3).

When the data transfer from the host computer 1 is started and “data A” of the first block is normally transferred, “data A” is held into FIFO-A in the FIFO 14 (refer to (a) and (b) of FIG. 3).

When “data A” is held in FIFO-A in the FIFO 14, since both of the READY signal and the ENA signal are set to the “H” level, the writing operation into the input buffer 27 is started (refer to (b) and (d) of FIG. 3).

Although the count value RD_CNT of the first counter 21 is updated to “+1” in response to the leading edge of the WR signal from the FIFO 14, since the relation of RD_CNT>WD_CNT is not satisfied between the count value RD_CNT and the count value WD_CNT in the comparator 23, the output of the comparator 23 is set to the “L” level. Thus, the output of the WRX signal via the gate 24 is inhibited and the writing operation to the input buffer 27 of the data (“data A” ) of the first block which has already been written in the input buffer 27 is not executed yet. That is, the data of the first block is abandoned.

Subsequently, the data of the second block is transferred to FIFO-B in the FIFO 14 and, similarly, the count value WD_CNT of the second counter 22 is updated. The count value RD_CNT and the count value WD_CNT are compared in the comparator 23. In the data of the second block, the data obtained until the relation of RD_CNT>WD_CNT is satisfied is abandoned in a manner similar to the data of the first block. When the relation of RD_CNT>WD_CNT is satisfied, the output of the comparator 23 is set to the “H” level. The WRX signal as an inversion output of the WR signal is inputted into the input buffer 27 via the gate 24 and the writing operation is executed (refer to (d) of FIG. 3). The count value WD_CNT of the second counter 22 is updated in response to the leading edge of the WRX signal (refer to (d) and (e) of FIG. 3). Thus, the data (“data B”) of the second block is written into the input buffer 27.

Subsequently, the data of the third block is transferred to FIFO-B in the FIFO 14. Similarly, the writing operation into the input buffer 27 is executed and the count value RD_CNT of the first counter 21 and the count value WD_CNT of the second counter 22 are updated (refer to (d) and (e) of FIG. 3).

When the transfer is continued and the relation of WD_CNT=LEN_REG is satisfied in the comparator 26, a reception end interruption signal is generated and the transfer of all data is finished (refer to (b) and (e) of FIG. 3).

As mentioned above, when the retransfer is executed due to the occurrence of the bus reset, since the data portion which has already been written in the input buffer 27 in the data which was retransferred is abandoned, the data can be transferred to the input buffer 27 in a continuous form. Thus, a situation such that the recording is retried from the beginning due to the interruption of the data transfer can be prevented.

Even if the bus reset due to the change in connecting state of another apparatus to the external bus 3 occurred, there is no need to stop the printing operation and newly start the printing. Therefore, the connecting form of the apparatus in the external bus 3 can be changed without being concerned about whether the data is being printed or not. The operability can be improved.

Deterioration of a throughput due to the stop of the printing can be prevented. Wasteful consumption of consumables such as printing medium, ink, and the like can be also prevented.

In the embodiment, although both of the first counter 21 and second counter 22 have been started from an initial value “0”, for example, it is also possible to set the first counter 21 to an initial value “0” and set the second counter 22 to an initial value “1”. In this case, it is sufficient to construct so as to set the output of the comparator 23 to the “H” level when RD_CNT=WD_CNT.

The first counter 21 and second counter 22 can be constructed by down-counters. In this case, it is also possible to construct in a manner such that the maximum value of the count value of each counter is set to the initial value and the output of the comparator 23 to the “H” level when RD_CNT<WD_CNT.

In the embodiment, although the control is made so as to hold the count value WD_CNT of the second counter 22 at the start of the retransfer, naturally, it is also possible to construct in a manner such that a register to hold the count value WD_CNT of the second counter 22 is provided and the value in the register is compared with the count value RD_CNT of the first counter 21 by the comparator 23.

(Second Embodiment)

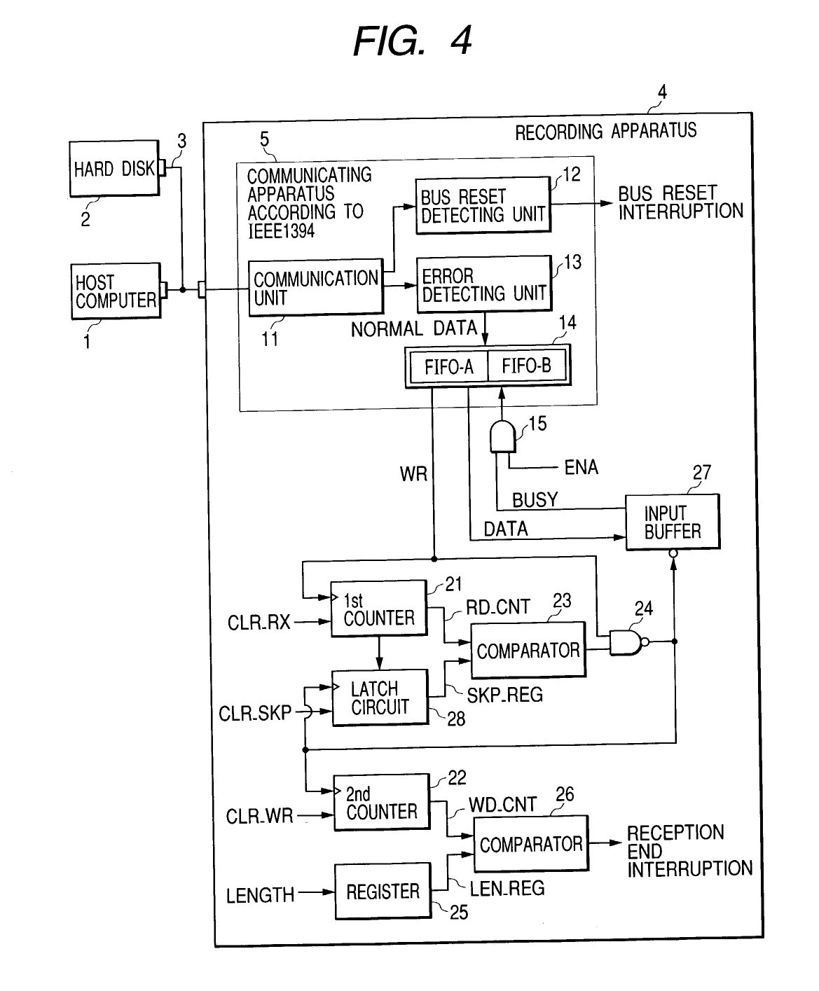

The second embodiment of the invention will now be described with reference to FIG. 4. FIG. 4 is a block diagram showing a construction of a principal section of a recording apparatus according to the second embodiment of the invention. In the diagram, the same and similar functional blocks as those in FIG. 1 are designated by the same reference numerals and their descriptions are omitted here.

In the embodiment, a latch circuit 28 to latch a value which is obtained when the count value RD_CNT of the first counter 21 changes most as a value SKP_REG is provided. The value which is obtained when the count value RD_CNT of the first counter 21 changes most corresponds to the maximum value in the case where the first counter 21 is an up-counter and corresponds to the minimum value in the case where the first counter 21 is a down-counter. That is, the SKP_REG value which is latched by the latch circuit 28 is equal to the value of the first counter 21 at the time of the bus reset or at the time of occurrence of the abnormality of the data transfer. It is now assumed that the first counter 21 is the up-counter and the value which is latched by the latch circuit 28 is the maximum count value of the first counter 21. The value SKP_REG of the latch circuit 28 is cleared by CLR_SKP from the CPU (not shown).

The value SKP_REG of the latch circuit 28 is compared with the count value RD_CNT of the first counter 21 by the comparator 23. If the retransfer of the data is now performed due to the occurrence of the bus reset, by holding the value SKP_REG of the latch circuit 28, until a relational expression of RD_CNT>SKP_REG (in case of the down-counter, RD_CNT<SKP_REG) is satisfied in the comparator 23, in a manner similar to the first embodiment mentioned above, the output of the WR signal from the gate 24 to the input buffer 27 is inhibited. When the relational expression of RD_CNT>SKP_REG (in case of the down-counter, RD_CNT<SKP_REG) is satisfied, the data writing operation into the input buffer 27 is executed. Therefore, if the retransfer is executed due to the occurrence of the bus reset, the data which has already been written in the input buffer 27 in the data which was retransferred is abandoned and the data can be transferred to the input buffer 27 in a continuous form.

As described above, according to the embodiment of the invention, when the transfer of the print data is interrupted and the retransfer of the print data is started, the first and second counters are controlled so as to initialize the count value of the first counter and hold the count value of the second counter, and a control is made in a manner such that the data read out from the first buffer is abandoned for a period of time from the start of the retransfer of the print data until it is determined by the output of the comparing means that the data is the data which has already been written in the second buffer, and if it is decided by the output of the comparing means that the writing into the second buffer is not executed yet, the data read out from the first buffer is written into the second buffer. Therefore, a situation such that the recording is retried from the beginning due to the interruption of the data transfer can be prevented.

According to the embodiment of the invention, when the transfer of the print data is interrupted and the retransfer of the print data is started, the first counter is controlled so as to initialize the count value of the first counter, and a control is made in a manner such that the data read out from the first buffer is abandoned for a period of time from the start of the retransfer of the print data until it is determined by the output of the comparing means that the data is the data which has already been written in the second buffer, and if it is decided by the output of the comparing means that the writing into the second buffer is not executed yet, the data read out from the first buffer is written into the second buffer. Therefore, a situation such that the recording is retried from the beginning due to the interruption of the data transfer can be prevented.

According to the embodiment of the invention, when the transfer of the print data is interrupted and the retransfer of the print data is started, the counter is controlled so as to initialize the count value of the counter, and a control is made in a manner such that the data read out from the first buffer is abandoned for a period of time from the start of the retransfer of the print data until the count value of the counter exceeds the count value held in the register, and when the count value of the counter exceeds the count value held in the register, the data read out from the first buffer is written into the second buffer. Therefore, a situation such that the recording is retried from the beginning due to the interruption of the data transfer can be prevented.

According to the embodiment of the invention, an amount of data received from the external apparatus and stored in a memory is managed, when the data reception is restarted, on the basis of the management of the data amount, the data up to the previously stored data in the data received again from the external apparatus is not stored into the memory, but the data after the previously stored data in the data received again from the external apparatus is written into the memory. Therefore, a situation such that the recording is retried from the beginning due to the interruption of the data transfer can be prevented.

What is claimed is:

1. A recording apparatus which is connected to an external apparatus via an interface that can divide print data from said external apparatus on a block unit basis and transfer it and, in the case where the transfer of said print data is interrupted, can retransfer said print data and which executes a print output on the basis of the print data transferred via said interface, comprising:
a first buffer for holding and managing said print data transferred via said interface on a block unit basis;
a second buffer for storing the print data read out from said first buffer;
a first counter for counting the number of data read out from said first buffer;
a second counter for counting the number of data written in said second buffer; and
a comparing unit of said first and second counters,
wherein when the transfer of said print data is interrupted and the retransfer of said print data is started, said first and second counters are controlled so as to initialize a count value of said first counter and hold a count value of said second counter, and
a control is made in a manner such that the data read out from said first buffer is abandoned for a period of time from the start of the retransfer of said print data until it is determined by an output of said comparing unit that the data is the data which has already been written into said second buffer, and if it is decided by the output of said comparing unit that the writing into said second buffer is not executed yet, the data read out from said first buffer is written into said second buffer.

2. An apparatus according to claim 1, wherein said interface is an interface according to the IEEE1394 standard, the data which is divided on said block unit basis and transferred corresponds to data stored in each packet, and the interruption of the transfer of said print data is executed when a bus reset occurs or when abnormality of the transfer data occurs.

3. A recording apparatus which is connected to an external apparatus via an interface that can divide print data from said external apparatus on a block unit basis and transfer it and, in the case where the transfer of said print data is interrupted, can retransfer said print data and which executes a print output on the basis of the print data transferred via said interface, comprising:
a first buffer for holding and managing said print data transferred via said interface on a block unit basis;
a second buffer for storing the print data read out from said first buffer;
a first counter for counting the number of data read out from said first buffer;
a second counter for counting the number of data written in said second buffer;
a register for holding a count value of said second counter; and
a comparing unit of said first counter and said register,
wherein when the transfer of said print data is interrupted and the retransfer of said print data is started, said first counter is controlled so as to initialize a count value of said first counter, and
a control is made in a manner such that the data read out from said first buffer is abandoned for a period of time from the start of the retransfer of said print data until it is determined by an output of said comparing unit that the data is the data which has already been written into said second buffer, and if it is decided by the output of said comparing unit that the writing into said second buffer is not executed yet, the data read out from said first buffer is written into said second buffer.

4. An apparatus according to claim 3, wherein said interface is an interface according to the IEEE1394 standard, the data which is divided on said block unit basis and transferred corresponds to data stored in each packet, and the interruption of the transfer of said print data is executed when a bus reset occurs or when abnormality of the transfer data occurs.

5. A recording apparatus which is connected to an external apparatus via an interface that can divide print data from said external apparatus on a block unit basis and transfer it and, in the case where the transfer of said print data is interrupted, can retransfer said print data and which executes a print output on the basis of the print data transferred via said interface, comprising:
a first buffer for holding and managing said print data transferred via said interface on a block unit basis;
a second buffer for storing the print data read out from said first buffer;
a counter for counting the number of data read out from said first buffer; and
a register for holding a count value of said counter which is obtained when it changes most,
wherein when the transfer of said print data is interrupted and the retransfer of said print data is started, said counter is controlled so as to initialize the count value of said counter, and
a control is made in a manner such that the data read out from said first buffer is abandoned for a period of time from the start of the retransfer of said print data until the count value of said counter exceeds the count value held in said register, and when the count value of said counter exceeds the count value in said register, the data read out from said first buffer is written into said second buffer.

6. An apparatus according to claim 5, wherein said interface is an interface according to the IEEE1394 standard, the data which is divided on said block unit basis and transferred corresponds to data stored in each packet, and the interruption of the transfer of said print data is executed when a bus reset occurs or when abnormality of the transfer data occurs.

7. An interface control method which is used in a recording apparatus which is connected to an external apparatus via an interface that can divide print data from said external apparatus on a block unit basis and transfer it and, in the case where the transfer of said print data is interrupted, can retransfer said print data and which executes a print output on the basis of the print data transferred via said interface, comprising the steps of:
holding and managing said print data transferred via said interface into a first buffer on a block unit basis;
counting the number of data read out from said first buffer by a first counter;
writing the print data read out from said first buffer into a second buffer;
counting the number of data written in said second buffer by a second counter;
controlling said first and second counters in a manner such that when the transfer of said print data is interrupted and the retransfer of said print data is started, a count value of said first counter is initialized and a count value of said second counter is held; and
making a control in a manner such that the data read out from said first buffer is abandoned for a period of time from the start of the retransfer of said print data until it is determined by comparing the count value of said first counter with the count value of said second counter that the data is the data which has already been written into said second buffer, and if it is decided by comparing the count value of said first counter with the count value of said second counter that the writing into said second buffer is not executed yet, the data read out from said first buffer is written into said second buffer.

8. A method according to claim 7, wherein said interface is an interface according to the IEEE1394 standard, the data which is divided on said block unit basis and transferred corresponds to data stored in each packet, and the interruption of the transfer of said print data is executed when a bus reset occurs or when abnormality of the transfer data occurs.

9. An interface control method which is used in a recording apparatus which is connected to an external apparatus via an interface that can divide print data from said external apparatus on a block unit basis and transfer it and, in the case where the transfer of said print data is interrupted, can retransfer said print data and which executes a print output on the basis of the print data transferred via said interface, comprising the steps of:
holding and managing said print data transferred via said interface into a first buffer on a block unit basis;
counting the number of data read out from said first buffer by a first counter;
writing the print data read out from said first buffer into a second buffer;
counting the number of data written in said second buffer by a second counter;
holding a count value of said second counter into a register;
controlling said first counter so as to initialize the count value of said first counter when the transfer of said print data is interrupted and the retransfer of said print data is started; and
making a control in a manner such that the data read out from said first buffer is abandoned for a period of time from the start of the retransfer of said print data until it is determined by comparing the count value of said first counter with the count value held in said register that the data is the data which has already been written into said second buffer, and if it is decided by comparing the count value of said first counter with the count value in said register that the writing into said second buffer is not executed yet, the data read out from said first buffer is written into said second buffer.

10. A method according to claim 9, wherein said interface is an interface according to the IEEE1394 standard, the data which is divided on said block unit basis and transferred corresponds to data stored in each packet, and the interruption of the transfer of said print data is executed when a bus reset occurs or when abnormality of the transfer data occurs.

11. An interface control method which is used in a recording apparatus which is connected to an external apparatus via an interface that can divide print data from said external apparatus on a block unit basis and transfer it and, in the case where the transfer of said print data is interrupted, can retransfer said print data and which executes a print output on the basis of the print data transferred via said interface, comprising the steps of:
holding and managing said print data transferred via said interface into a first buffer on a block unit basis;
counting the number of data read out from said first buffer by a counter;
writing the print data read out from said first buffer into a second buffer;
holding a count value of said counter which is obtained when it changes most into a register;
controlling said counter so as to initialize the count value of said counter when the transfer of said print data is interrupted and the retransfer of said print data is started; and
making a control in a manner such that the data read out from said first buffer is abandoned for a period of time from the start of the retransfer of said print data until the count value of said counter exceeds the count value held in said register, and when the count value of said counter exceeds the count value in said register, the data read out from said first buffer is written into said second buffer.

12. A method according to claim 11, wherein said interface is an interface according to the IEEE1394 standard, the data which is divided on said block unit basis and transferred corresponds to data stored in each packet, and the interruption of the transfer of said print data is executed when a bus reset occurs or when abnormality of the transfer data occurs.

13. An interface control apparatus comprising:
a management unit for managing an amount of data received from an external apparatus and stored in a memory; and
writing means which operates in a manner such that when data is again received from said external apparatus, on the basis of the management by said management unit, the data up to the previously stored data in the data received again from said external apparatus is not stored into the memory, and the data after the previously stored data in the data received again from said external apparatus is written into the memory.

14. An interface control method comprising:
a management step of managing an amount of data received from an external apparatus and stored in a memory; and
a writing step which operates in a manner such that when data is again received from said external apparatus, on the basis of the management by said management step, the data up to the previously stored data in the data received again from said external apparatus is not stored into the memory, and the data after the previously stored data in the data received again from said external apparatus is written into the memory.
